(19) United States
(12) Patent Application Publication
(10) Pub. No.: US 2026/0309309 A1
(43) Pub. Date: Oct. 8, 2026

(54) REFLECTOR CUP AND LUMINAIRE

(71) Applicant: SIGNIFY HOLDING B.V., EINDHOVEN (NL)

(72) Inventors: RENÉ BELTMAN, VUGHT (NL); MICHAEL CORNELIS JOSEPHUS MARIE VISSENBERG, ROERMOND (NL)

(21) Appl. No.: 19/481,462

(22) PCT Filed: Apr. 18, 2024
(86) PCT No.: PCT/EP2024/060524

§ 371 Date: Nov. 4, 2025

(30) Foreign Application Priority Data
May 4, 2023 (EP) 23171454.4
May 4, 2023 (EP) 23171493.2

(51) Int. Cl. F21V 7/09; F21S 8/04; F21V 7/00; F21V 7/22; F21Y 115/10

(52) U.S. Cl. CPC F21V 7/09; F21S 8/04; F21V 7/0083; F21V 7/22; F21Y 2115/10

(57) ABSTRACT

The present invention relates to a reflector cup (10) comprising: a base (12) for a light source (14); a light emission window (16) opposite the base, wherein the light emission window has a larger area than the base; an optical axis (18) extending through the base and the light emission window; and a circumferential reflective side wall (20) extending around the optical axis and connecting the base and the light emission window, wherein one of the light emission window, the light source, and the base has a non-regular shape, and wherein different regions (30a-b; 32a-b) of the reflective side wall at different locations around the optical axis have different curvatures (34; 36) as seen in a plane in which the optical axis extends.

### FIELD OF THE INVENTION

The present invention relates to a reflector cup, in particular for a luminaire. The present invention also relates to a luminaire comprising a plurality of such reflector cups.

### BACKGROUND OF THE INVENTION

Many luminaires have diffusely reflecting or semi-specular cups around the light source to improve their visual comfort. The cup prevents direct visibility of the bright source and increases the luminous area of the luminaire. The cups are often illuminated by the sources such that the illuminance on the cup decreases radially outward from the source. This results in a gradient in the luminance from the bright source to the darker outer edges of the cup that is often perceived as aesthetically pleasing.

US2013201690A1 discloses a luminaire in one piece, which is built up of a plurality of illumination devices. Each illumination device comprises a reflector bordering, with an outer edge, on a light emission window. The reflector has a reflective surface facing the light emission window. The illumination device further comprises lamp holding means for accommodating a light source. The luminaire illustrated in FIG. 2 of US2013201690A1 has 4×4=16 square illumination devices.

U.S. Pat. No. 6,048,084A discloses an illumination reflector for area projection.

US2013044495A1 discloses a lighting fixture equipped with a shaped reflector.

CN102620239B discloses a floodlight reflector and light emitting diode (LED) luminaire.

### SUMMARY OF THE INVENTION

In a square reflector cup, like the reflectors in FIG. 2 of US2013201690A1, all sides of the cup may receive equal flux, whereby the luminance of all cup sides is the same.

However, if the cups are not square but, for example, rectangular, the luminance of the different cup sides can be very different. The luminance peak on one side can be multiple times brighter than the luminance peak on another side. Also, the luminance profile radially outward can be very different between different cup sides. For a rectangular cup, the sides closer to the source may be significantly brighter than the sides farther away from the source. It could also be that for every cup multiple LEDs are used that are positioned next to each other. The source area might then be rectangular instead of square, which results in sides of a square reflector cup that are much brighter than others.

It is an object of the present invention to overcome these problems, and to provide an improved reflector cup. The invention is set out in the appended set of claims.

According to a first aspect of the invention, this and other objects are achieved by a reflector cup, in particular for a luminaire, the reflector cup comprising: a base for a light source; a light emission window opposite the base, wherein the light emission window has a larger area than the base; an optical axis extending through the base and the light emission window; and a circumferential (light) reflective side wall extending around the optical axis and connecting the base and the light emission window, wherein the base, and the light emission window mutually differ in shape more than just in size, for example, wherein the base is a square base and the light emission window is a rounded rectangle, and wherein different regions of the reflective side wall at different locations around the optical axis have different curvatures as seen in a plane in which the optical axis extends. The circumferential side wall comprises a first pair of diagonally arranged first corners with a first curvature radius, and comprises a second pair of diagonally arranged second corners with a second curvature radius, wherein the first curvature radius is different from the second curvature radius.

The present invention is at least partly based on the understanding that by designing the reflector cup so that different regions of the reflective side wall at different locations around the optical axis have different curvatures, a more even luminance distribution in the cup may be achieved, even when the light emission window or the light source has a non-regular (e.g. rectangular) shape. In other words, the regions/cup sides with different curvatures allows to significantly improve the uniformity of the luminance over the different cup sides.

The first corners of the first pair arranged have the same first curvature radius and the second corners of the second pair have the same second curvature radius. It is known that a closed tessellated surface can be made by squares and rectangles. Hence, with reflector cups having light exit windows shaped as squares or rectangles (the look of) a comparatively uniform illuminating surface can be relatively easy be attained by an arrangement of a plurality of reflector cups in a plane. Yet, a closed tessellated surface of reflector cups with round, circular shaped light exit windows is not possible and darker (non-light emitting) areas between the reflector cups are typically present. By setting the first and second curvature radii of the diagonally different pairs of rounded corners, it enabled to tune the fraction of darker areas between the light exit windows of the reflector cups and thus to tune the uniformity of the illuminating surface formed by the tessellated arrangement of the reflector cups in a plane. Further by setting the first and second curvature radii of the diagonally different pairs of rounded corners it is enabled to choose a specific, desired asymmetric beam pattern of the light beam instead of a normal, symmetric light beam from a “standard” reflector. Yet, the normal symmetric beam is can still be obtained by arranging a cluster of four of such reflector cups around a central point so as to form a rotationally and/or mirror symmetric cup arrangement.

The first curvature radius can be constant or can slight vary over the angle of the first corner. If the first radius varies over the angle, then the average radius is taken as the first curvature radius. Similarly, this applies to the second curvature radius. Typically, the first curvature radius is larger than the second curvature radius by a factor in the range of 2 to 12, such as 4 or 8. The rounded shape of the corners and circumferential wall counteracts the risk on undesired, distinct artefacts in the beam pattern. This typical asymmetric shape as such may be considered a separate invention.

The rounded rectangular light emission window may substantially be shaped as a rhomboid leaf, i.e. resembles the shape of a rhomboid leaf. This specific shape of the reflector cup transforms the light exit window of the luminaire from a “standard”, geometric appearance to a light texture, where designers can choose from a number of different styles to match their design intent. This also creates customization opportunities for recessed luminaires, which traditionally have limited aesthetic variation, and for face trim plates having a textured appearance. This typical shape as such may be considered a separate invention.

Square, in the context of the invention, may be understood as that the edges of the sides of the square have lengths Le that may mutually differ at the most by 10%, such as by <=5%, preferably by <=2%, more preferably by <=0.3%, most preferably by 0% (yet considering measurement errors). The sides may extend at mutual angles α of 90°±5°, such 90°±2°, preferably at 90°±1°, most preferably at 90°±0° (yet considering measurement errors). The (square) light source may be located at the center of the (square) base, or located slightly off-center by at the most 10% of a length Lls of the long edge of the light source.

The aforementioned US2013201690A1 does disclose that “the intersection between the edge of the wide end and/or narrow end and the light emission window may be circular, elliptical or polygonal.” but that “Especially tapered reflectors having an elliptical or rectangular shape of the intersection may be useful in corridor lighting, in which the beam profile could be made asymmetric either to enhance the wall illumination, for example wide beam to the walls, narrow beams parallel to the walls to avoid glare, or conversely, the beam could be made narrower towards the walls, to save energy, and wider along the corridor to increase luminaire spacing and save cost”. Hence, US2013201690A1 does not disclose that different regions of a reflective side wall at different locations around the optical axis have different curvatures as seen in a plane in which the optical axis extends, to improve the uniformity of luminance over the different regions/sides of the cup.

Furthermore, CN201355002Y discloses a plurality of reflective cups being conjoined together to form the conjoint reflective cup, each reflective cup consists of a cup body and a cup leg, the axial section of the cup body is shaped like a trapezoid, the radial section of the cup body is shaped like a rectangle, and the axial section of the cup leg is approximately shaped like a reverse concave. However, CN201355002Y does at least not disclose that different regions of a reflective side wall at different locations around the optical axis have different curvatures as seen in a plane in which the optical axis extends, to improve the uniformity of luminance over the different regions/sides of the cup.

The different regions of the reflective side wall at different locations around the optical axis may have different curvatures as seen in a plane in which the optical axis extends such that the peak luminance contrast between the different regions is less than 2:1, preferably less than 1.3:1, and more preferably less than 1.1:1, when the light source illuminates the reflective side wall. That is, the peak luminance (when the light source is ON) on any of the different regions is less than two times higher than the peak luminance on any of the other different regions of the reflective side wall. Furthermore, the different regions of the reflective side wall at different locations around the optical axis may have different curvatures as seen in a plane in which the optical axis extends such that the uniformity of luminance over the different regions is improved compared to a reflector cup where the regions/sides of the circumferential reflective side wall do not have different curvatures, for example where the reflective side wall has flat sides.

Said different regions of the reflective side wall may be correlated with the non-regular shape of the light emission window or the light source. For example, the non-regular shape of the light emission window or the light source may be polygonal, wherein the different regions of the reflective side wall are discrete sides, and wherein the number of discrete sides corresponds the number of corners of the polygonal non-regular shape of the light emission window. In one or more other embodiments, the non-regular shape of the light emission window may be curvilinear. That is, the light emission window can also have a curvilinear boundary.

The different regions of the reflective side wall may comprise at least: a first region at a first location around the optical axis, which first region has a first curvature as seen in a plane in which the optical axis extends; and a second region at a second location around the optical axis different than the first location, which second region has a second curvature different than the first curvature as seen in a plane in which the optical axis extends.

The light emission window may have a non-regular shape (i.e. option a) in claim 1) with a major axis and a minor axis orthogonal to (and shorter than) the major axis, wherein the different regions of the reflective side wall include two opposing first regions, one located at each end of the major axis, and two opposing second regions, one located at each end of the minor axis, wherein (in the direction along the optical axis) the curvatures of the two opposing first regions are concave as seen from outside the reflector cup, and wherein (in the direction along the optical axis) the curvatures of the two opposing second regions are convex as seen from outside the reflector cup.

The non-regular shape with a major axis and a minor axis orthogonal to the major axis may for example be rectangular having two long edges parallel to the major axis and two short edges parallel to the minor axis, wherein the two (concave) opposing first regions each connects the base and a respective one of said short edges, and wherein the two (convex) opposing second regions each connects the base and a respective one of said long edges. The regions of the circumferential reflective side wall may be discrete sides: the two opposing first regions may be two first discrete sides, and the two opposing second regions may be two second discrete sides. The base and/or the light source may be square. The (square) light source may be located at the center of the (square) base.

The curvature of the two opposing first regions may be given by h(x) ∝ x^{A}, wherein 0.5≤A<1, wherein the curvature of the two opposing second regions is given by h(x) ∝ x^{B}, wherein 1<B≤2, and where h is height of the reflector cup along the optical axis and x is radial distance from the optical axis.

In one variant, 0.55≤A≤0.75, such as A=0.65, and 1.5≤B≤1.7, such as B=1.6. In this way, the peak luminance is (substantially) the same on both the first regions and the second regions.

In another variant, A and B are closer to 1, i.e. the curvatures are less severe. For example, 0.85≤A<1 and 1<B≤1.4. In this way, the peak luminance may be at (substantially) the same radial distance from the optical axis for both the first regions and the second regions.

The non-regular shape with a major axis and a minor axis orthogonal to the major axis may alternatively be elliptical having two vertexes on the major axis and two co-vertexes on the minor axis, wherein the two (concave) opposing first regions each connects the base and a respective one of said vertexes, and wherein the two (convex) opposing second regions each connects the base and a respective one of said co-vertexes. The circumferential reflective side wall may here have a single smooth shape, rather than discrete sides. The base and/or the light source may be circular. The (circular) light source may be located at the center of the (circular) base.

The non-regular shape of the light emission window may be selected form the group consisting of: (non-square) rectangular, non-equilateral triangular, irregular hexagonal, and (non-circular) elliptical. That is, apart from the above-discussed shapes, the circumferential reflective side wall could have three sides (triangular) or more than four sides (e.g. hexagonal with six sides). The non-regular shape of the light emission window may even be a freeform shape. For all these non-regular shapes it is possible to change the curvatures along different directions of the reflector cup to improve the luminance uniformity and correct in this way for the asymmetry of the reflector cup.

In at least one other embodiment (option b) in claim 1), the light source is included in the reflector cup and has a rectangular shape with two long edges and two short edges; the light emission window has a square shape with four equal edges; the different regions of the reflective side wall include two opposing first regions, each connecting the base and a respective one of said equal edges such that each faces a respective one of the long edges of the rectangular shape of the light source, wherein the curvatures of the two opposing first regions are concave as seen from outside the reflector cup; and the different regions of the reflective side wall further include two opposing second regions, each connecting the base and a respective one of said equal edges such that each faces a respective one of the short edges of the rectangular shape of the light source, wherein the curvatures of the two opposing second regions are convex as seen from outside the reflector cup. The regions of the circumferential reflective side wall may be discrete sides. The base may be square. The rectangular light source may be located at the center of the (square) base. In this embodiment, the different regions of the circumferential reflective side wall may start at different distances from the light source, but the concave and convex curvatures may compensate for this, to improve the uniformity of the luminance over the different cup sides.

In at least one further embodiment (option c) in claim 1), the light source is included in the reflector cup and has a square shape; the base has a rectangular shape with two short edges 52a-b and two long edges 54a-b; the light emission window has a square shape with four equal edges; the different regions of the reflective side wall include two opposing first regions (30a-b), each connecting a respective one of said short edges of the base and a respective one of said equal edges (50), wherein the curvatures (34) of the two opposing first regions (30a-b) are concave as seen from outside the reflector cup; and the different regions of the reflective side wall further include two opposing second regions (32a-b), each connecting a respective one of said long edges of the base and a respective one of said equal edges, wherein the curvatures (36) of the two opposing second regions (32a-b) are convex as seen from outside the reflector cup. The regions of the circumferential reflective side wall may be discrete sides. The square light source may be located at the center of the (rectangular) base. In this embodiment, the different regions of the circumferential reflective side wall may start at different distances from the light source, but the concave and convex curvatures may compensate for this, to improve the uniformity of the luminance over the different cup sides.

The reflective side wall may be at least partially transflective. The purpose of the wall structure is to overcome certain optical issues, for example, an LED cluster associated with individual lenses may create, inside the reflector cup, a relatively strong inhomogeneous luminance profile of relatively bright points separated by relatively dark areas in between the lenses. For improved comfort, such contrast between the LEDs thus is reduced.

The reflective side wall may be one of: diffusely reflecting, at least partly diffusely reflecting, and semi-specular. Diffusivity that varies over the surface of the reflective side wall is also a possibility.

The light source may be comprised in the reflector cup and arranged at or on the base of the reflector cup. The base could be an opening or a have a surface on which the light source may be arranged. The light source may be comprised as an integrated, non-replaceable part with the reflector cup, i.e. permanently fixed to the reflector cup. The light source may be at least one light emitting diode (LED).

According to a second aspect of the present invention, there is provided a luminaire comprising a plurality of reflector cups according to the first aspect. The luminaire may for example comprise 16 reflector cups arranged in an 4×4 or 2×8 array. The plurality of reflector cups may be a cluster of four reflector cups are arranged around a central point so as to form a rotationally symmetric cup arrangement. The luminaire may for example be an indoor luminaire. The luminaire may for example be adapted to be mounted in or on a ceiling. The luminaire may for example be an office(-norm-compliant) LED luminaire.

The luminaire may comprise a plurality of light sources, one for each reflector cup. Each light source may be at least one light emitting diode (LED).

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 is a schematic perspective view of a reflector cup according to an embodiment of the present invention with a rectangular light emission window.

FIG. 2 is a top view of the reflector cup of FIG. 1.

FIG. 3a-b illustrate different regions of a circumferential reflective side wall of a reflector cup not falling under the scope of the present invention, and corresponding luminance values, respectively.

FIGS. 4a-b illustrate curvatures of different regions of a circumferential reflective side wall of a variant of the reflector cup of FIG. 1, and corresponding luminance values, respectively.

FIGS. 5a-b illustrate curvatures of different regions of a circumferential reflective side wall of another variant of the reflector cup of FIG. 1, and corresponding luminance values, respectively.

FIG. 6a is a top view of a reflector cup according to another embodiment of the present invention with an elliptical light emission window.

FIG. 6b-c are side views of the reflector cup of FIG. 6a.

FIG. 7a is a schematic perspective view of a reflector cup according to yet another embodiment of the present invention with a rectangular light source.

FIG. 7b is a top view of the reflector cup of FIG. 7a.

FIG. 8 is a schematic view of a reflector cup according to a further embodiment of the present invention with a rectangular base.

FIG. 9 is a schematic view of a luminaire according to another aspect of the present invention.

FIG. 10 shows a schematic view of a few reflector cups according a still further embodiment of the invention with a rhomboid leaf-like shape of the light emission window.

Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

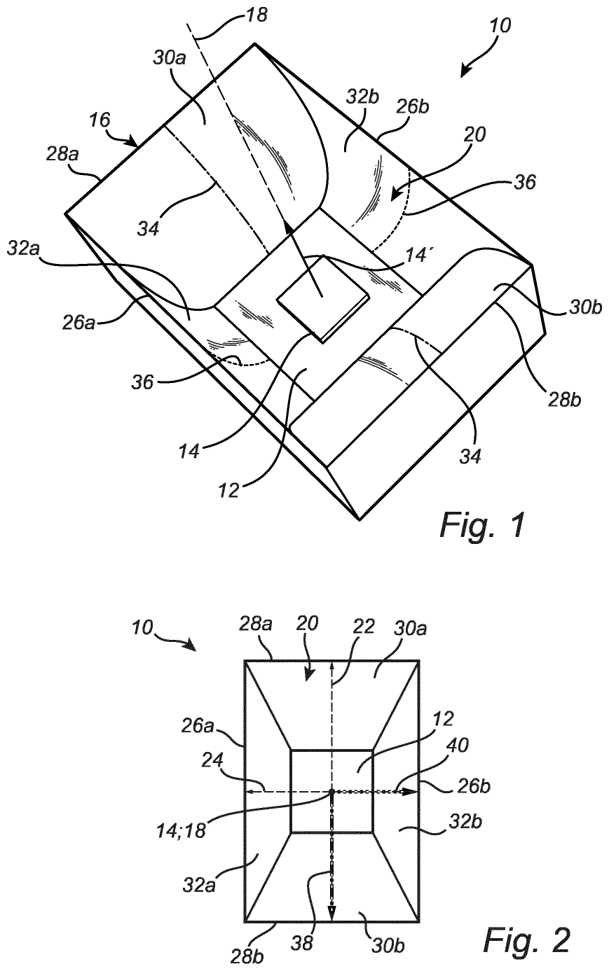

FIGS. 1-2 show a reflector cup 10, in particular for a luminaire 100 (see FIG. 9), according to an embodiment of the present invention.

The reflector cup 10 comprises a base 12 for a light source 14. The base 12 could be an opening in which the light source 14 is placed, or a have a surface on which the light source 14 is mounted. The base 12 in FIGS. 1-2 is square. The light source 14 may also be square (that is, have a regular shape). The light source 14 be for example be at least one LED adapted to emit LED light 14′ in the direction indicated in FIG. 1. The light source 14 may be located at the center of the base 12.

The reflector cup 10 further comprises a light emission window 16 opposite the base 14. The light emission window 16 has a larger area than the base 14. Furthermore, the light emission window 16 and the base 14 may extend transversely to the optical axis 18 of the reflector cup 10, although the light emission window 16 does not have to be (completely) contained in a plane perpendicular to the optical axis 18. In FIGS. 1-2, the light emission window 16 has a non-regular shape. Specifically, the non-regular shape of the light exit window 16 in FIGS. 1-2 is rectangular. As such, the non-regular shape of the light emission window 16 is here polygonal. Generally, the light emission window 16 could be an opening. Alternatively, the light emission window 16 could be made of material, preferably transparent material.

The reflector cup 10 further comprises a circumferential reflective side wall 20. The reflective side wall 20 extends (all) around the optical axis 18, and connects the base 12 and the light emission window 16. The reflective side wall 20 is generally adapted to reflect (LED) light emitted by the light source 14. The reflective side wall 20, specifically the inner surface thereof (facing the light emission window 16), may for example be diffusely reflecting or semi-specular.

In accordance with the present invention, different regions (for example 30a and 32b) of the reflective side wall 20 at different locations around the optical axis 28 have different curvatures (for example concave curvature 34 and convex curvature 36) as seen in planes in which the optical axis 18 extends, as illustrated in e.g. FIG. 4a. In this way, a more even luminance distribution in the reflector cup 10 may be achieved, as illustrated in e.g. FIG. 4b, even when the light emission window 16 has a non-regular (e.g. rectangular) shape, as will be explained more in the following.

The rectangular shape of the light emission window 16 in FIGS. 1-2 can be seen as having a major axis 22 and a minor axis 24 orthogonal to the major axis 22, wherein two long edges 26a-b of the light emission window 16 are parallel to the major axis 22 and two short edges 28a-b of the light emission window 16 are parallel to the minor axis 24. The aforementioned different regions of the reflective side wall 20 here include two opposing first regions 30a-b, each connecting the base 12 and a respective one of said short edges 28a-b. The different regions of the reflective side wall 20 further include two opposing second regions 32a-b, each connecting the base 12 and a respective one of said long edges 26a-b. The first and second regions 30a-b and 32a-b may be discrete sides, and the number of discrete sides (four) is equal to the number of corners of the rectangular shape of the light emission window 16.

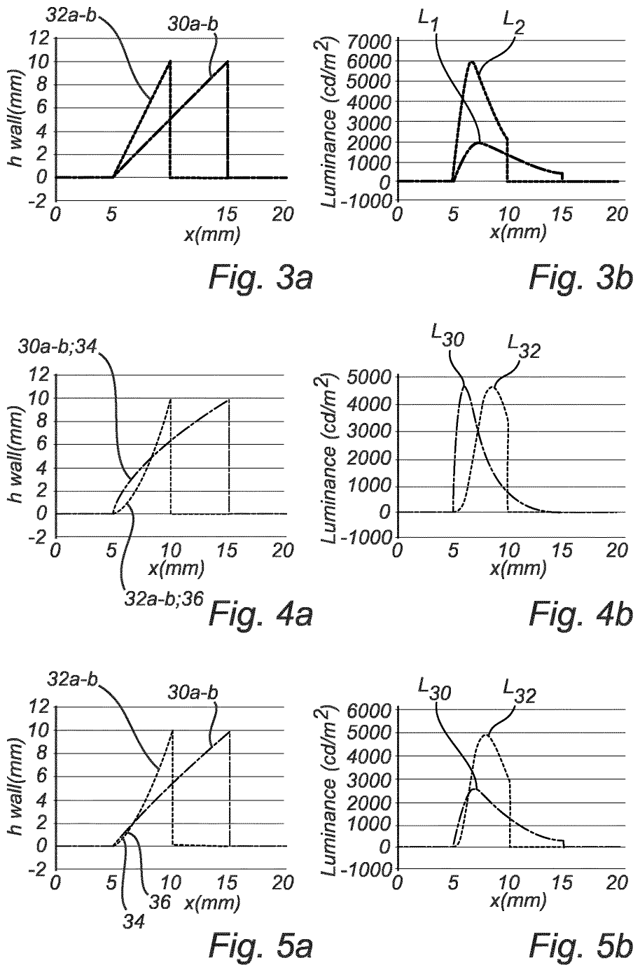

If the different regions of the reflective side wall 20 (e.g. regions 30a-b and 32a-b) did not have different curvatures as in the present invention, but instead were straight (i.e. the base 12 and the light emission window 16 are connected by straight line segments), as illustrated in FIG. 3a, one gets a peak luminance L₂ on the second regions 32a-b that is three times higher than the peak luminance L₁ on the first regions 30a-b (approx. 6000 cd/m² vs. 2000 cd/m²), as illustrated in FIG. 3b.

However, by making the curvatures 34 of the two opposing first regions 30a-b concave as seen from outside the reflector cup 10 (or convex as seen from the inside of the reflector cup 10), and the curvatures 36 of the two opposing second regions 32a-b convex as seen from outside the reflector cup 10 (or concave as seen from the inside of the reflector cup 10), the above-mentioned peak luminance difference may be countered. In the region/interface between a concave region (e.g. 30a) and a convex region (e.g. 32b) of the circumferential reflective side wall 20, the curvature may smoothly change from concave to less concave, to no-curvature, to some convex curvature, to more convex.

In the variant shown in FIG. 4a, the above-mentioned peak luminance difference is completely countered: the peak luminance L₃₀ and L₃₂ is the same (approx. 4800 cd/m²) on both the first regions 30a-b and the second regions 32a-b, as seen in FIG. 4b. Here, the peak luminance contrast between the different regions 32a-b and 30a-b is less than 1.1:1. In FIG. 4a, the curvature (slope) 34 of the two opposing convex first regions 30a-b is be given by h(x) ∝ x^{0.65}, whereas the curvature (slope) 36 of the two opposing concave second regions 32a-b is be given by h(x) ∝ x^{1.6}, where h is the height of the reflector cup 10 along the optical axis 18 and x is radial distance from the optical axis 18.

Because of the curvatures 34 and 36 in FIG. 4a, the peaks L₃₀ and L₃₂ are at different distances x to the light source 14, as seen in FIG. 4b. This may be avoided or alleviated by curving the regions 30a-b and 32a-b less severely. Such a variant is shown in FIGS. 5a-b, where the curvatures are chosen such that the curvatures (slopes) 34 and 36 are very similar close to the light source 14. The curvature (slope) 34 of the two opposing convex first regions 30a-b may here be h(x) ∝ x^{0.87}, whereas the curvature (slope) 36 of the two opposing concave second regions 32a-b may be h(x) ∝ x^{1.4}. Although the peak luminance L₃₂ on the two second regions 32a-b is now almost twice as high as the peak luminance L₃₀ on the two first regions 30a-b (the peak luminance contrast is here less than 2:1), the positions of the peaks L₃₀ and L₃₂ along the horizontal axis are closer in FIG. 5b than in FIG. 4b.

Assumptions for FIGS. 3a-b, 4a-b, and 5a-b: The light source 14 is considered being a point source located at the origin (i.e. the center of the base 12). The sides 30a-b and 32a-b start at x=5 mm from light source 14. The rectangular shape of the light emission window 16 is 20 mm×30 mm, hence sides 30a-b end at x=10 mm and sides 32a-b end at x=15 mm, in both cases at a height of h=10 mm. The intensity of the source is given by I(θ)=I₀ cos²(θ). The illuminance on the sides 30a-b and 32a-b were analytically calculated. It was assumed that the sides 30a-b and 32a-b reflect like a Lambertian scatterer, and this was used to calculate the resulting luminous of the sides 30a-b and 32a-b along the lines 38 and 40 indicated in FIG. 2. FIGS. 3a, 4a, and 5b show the height h of the sides 30a-b and 32a-b as a function of the distance x to the light source 14/optical axis 18. FIGS. 3b, 4b, and 5b show luminance values on the sides 30a-b and 32a-b as a function of the distance x to the light source 14/optical axis 18. That is, FIGS. 3b, 4b, and 5b show the luminance profiles along the lines 38 and 40 in FIG. 2. It can be noted that vertical axis in FIGS. 3a-b, 4a-b, and 5a-b coincide with the optical axis 18. Hence, FIGS. 4a and 5a show at least one plane in which the optical axis 18 extends. Also in FIGS. 3a-b, 4a-b, and 5a-b, the horizontal axis may coincide or at least be parallel to the base 12.

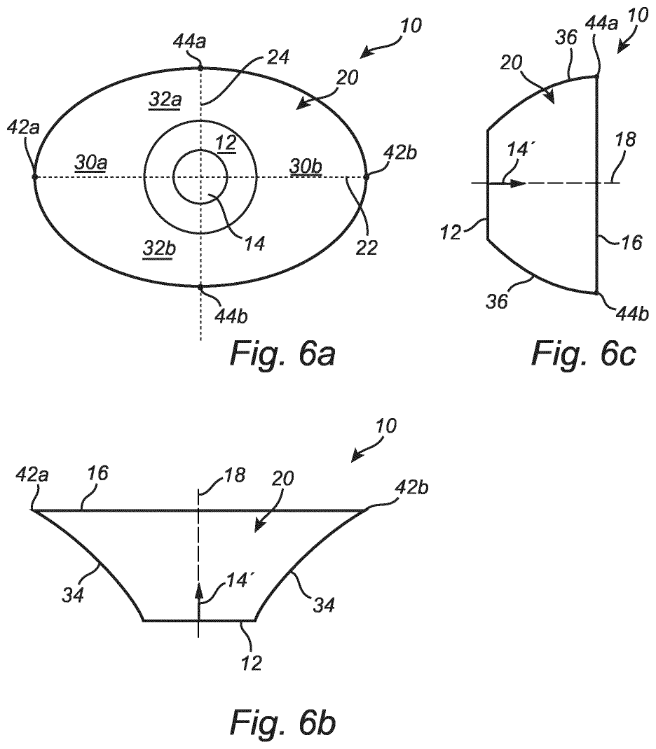

FIGS. 6a-c show a reflector cup 10 according to another embodiment of the present invention, with an elliptical light emission window 16. That is, the non-regular shape of the light emission window 16 is here elliptical, specifically with two vertexes 42a-b on the major axis 22 and two co-vertexes 44a-b on the minor axis 24, as illustrated in FIG. 6a. Furthermore, the two concave opposing first regions 30a-b of the circumferential reflective side wall 20 here each connects the base 12 and a respective one of the vertexes 42a-b, wherein the two convex opposing second regions 32a-b each connects the base 12 and a respective one of the co-vertexes 44a-b. The concave curvatures 34 of the two opposing first regions 30a-b are clearly seen in FIG. 6b, and the convex curvatures 36 of the two opposing second regions 32a-b are clearly seen in FIG. 6c. These concave curvatures 34 and convex curvatures 36 can bring the peak luminances along the two directions 22 and 24 closer together, similar to FIG. 5b. It is also appreciated that the circumferential reflective side wall 20 here has a single smooth shape, rather than discrete sides as in FIGS. 1-2. The base 12 and/or the light source 14 may here be circular. The light source 14 may be located at the center of the base 12. The light source 14 be for example be at least one LED adapted to emit LED light 14′ in the direction indicated in FIGS. 6b-c.

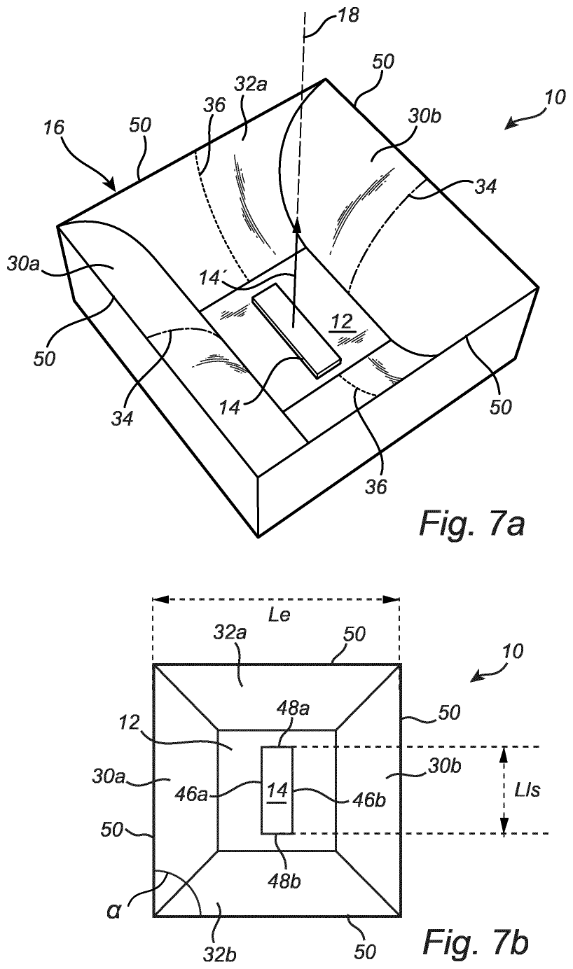

FIGS. 7a-b show a reflector cup 10 according to yet another embodiment of the present invention. Here, the light source 14 is included in the reflector cup 10. Furthermore, the light source 14 has a non-regular shape, specifically a rectangular shape with two long edges 46a-b having a length Lls and two short edges 48a-b. The light emission window 16 has a square shape, with four equal edges 50. The edges 50 each have a respective length Le and adjacent edges 50 are oriented at mutual angles α of (about) 90°. The different regions of the circumferential reflective side wall 20 include two opposing first regions 30a-b, each connecting the base 12 and a respective one of the equal edges 50 such that each faces a respective one of the long edges 46a-b, wherein the curvatures 34 of the two opposing first regions 30a-b are concave in a plane in which the optical axis 18 extends and as seen from outside the reflector cup 10. The different regions of the reflective side wall 20 further include two opposing second regions 32a-b, each connecting the base 12 and a respective one of the equal edges 50 such that each faces a respective one of the short edges 48a-b, wherein the curvatures 36 of the two opposing second regions 42a-b are convex in a plane in which the optical axis 18 extends and as seen from outside the reflector cup. The regions 30a-b and 32a-b of the circumferential reflective side wall 20 may here be discrete sides. The base 12 may be square. The rectangular light source 14 may be located at the center of the base 12. The light source 14 be for example be a plurality of LEDs adapted to emit LED light 14′ in the direction indicated in FIG. 7a. In this embodiment, the different regions of the circumferential reflective side wall 20 may start at different distances from the light source 14, but the concave and convex curvatures 34 and 36 may compensate for this, to improve the uniformity of the luminance over the different cup sides 30a-b and 32a-b.

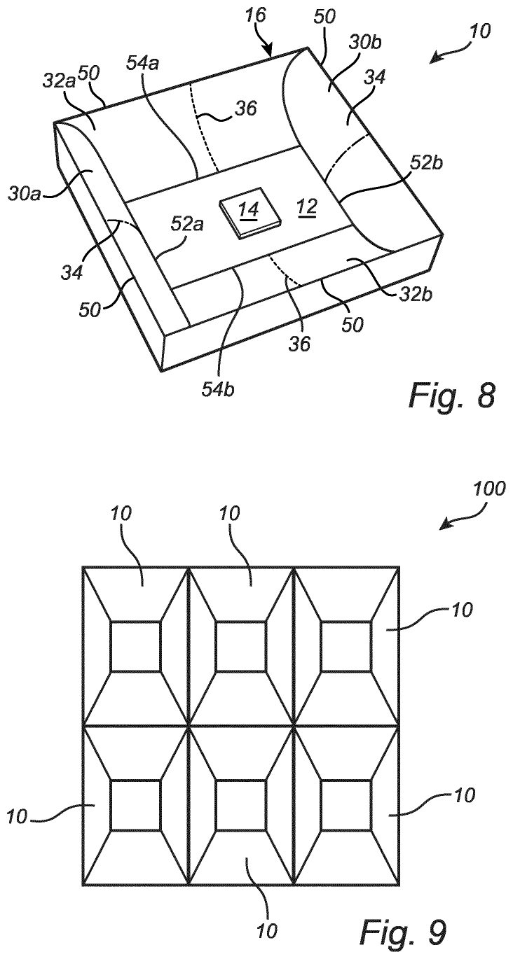

FIG. 8 shows a reflector cup 10 according to a further embodiment of the present invention. Here, the light source 14 has a square shape and may be included in the reflector cup 10. Furthermore, the base 12 has a non-regular shape, specifically a rectangular shape with two short edges 52a-b and two long edges 54a-b. The light emission window 16 has a square shape, with four equal edges 50. The different regions of the reflective side wall 20 include two opposing first regions 30a-b, each connecting a respective one of said short edges 52a-b and a respective one of the equal edges 50 of the light emission window 16, wherein the curvatures 34 of the two opposing first regions 30a-b are concave (as seen from outside the reflector cup 10). The different regions of the reflective side wall 20 further include two opposing second regions 32a-b, each connecting a respective one of the long edges 54a-b and a respective one of the equal edges 50, wherein the curvatures 36 of the two opposing second regions 32a-b are convex (as seen from outside the reflector cup 10). The regions 30a-b and 32a-b of the circumferential reflective side wall 20 may here be discrete sides. The square light source 14 may be located at the center of the (rectangular) base 12. In this embodiment, the different regions 30a-b and 32a-b of the circumferential reflective side wall 20 may start at different distances from the light source 14, but the concave and convex curvatures 34 and 36 may compensate for this, to improve the uniformity of the luminance over the different cup sides 30a-b and 32a-b.

FIG. 9 shows a luminaire 100 according to an aspect of the present invention. The luminaire 100 comprises a plurality of reflector cups 10 according to any embodiment described hereinabove. The luminaire 100 may for example comprises a plurality of reflector cups 10 with a rectangular light emission window 16. The reflector cups 10 of the luminaire 100 may be arranged in an array, for example a 2×3 array as in FIG. 8. However, other arrangements are possible, such as a 4×4 array or a 2×8 array. Accordingly, the luminaire 100 may comprise 6 to 16 reflector cups 10, for example. The luminaire 100 may also comprise light sources 14, one for each reflector cup 10. Accordingly, the luminaire 100 may be an LED luminaire. Furthermore, the luminaire 100 may be an indoor luminaire, for indoor lighting such as office lighting. The luminaire 100 may for example (be adapted to) be mounted in or on a ceiling.

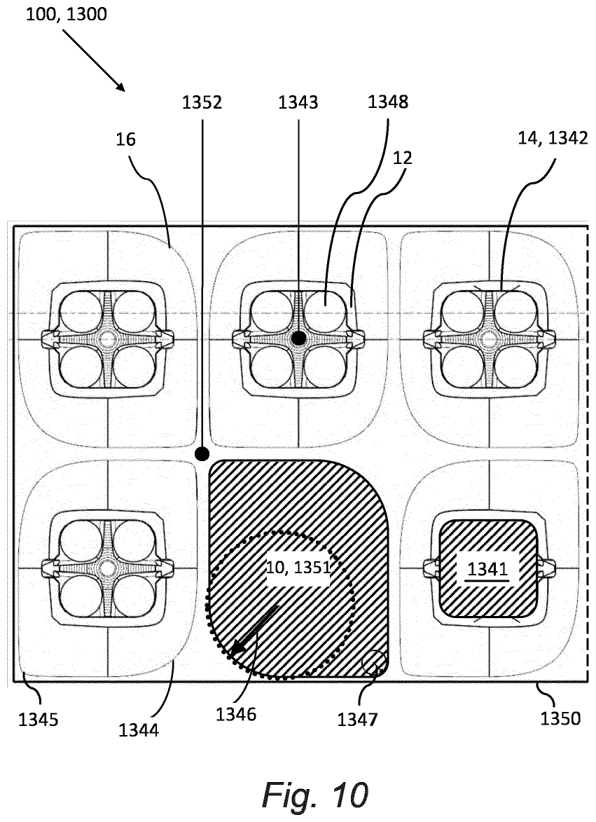

FIG. 10 shows a schematic view of a part of a luminaire 100,1300 comprising an arrangement or cluster of reflector cups 10,1351 according a still further embodiment of the invention with a rhomboid leaf-like shape of the light emission window 16 of each reflector cup. The circumferential side wall 20 comprises a first pair of diagonally arranged first corners 1344 with a first curvature radius 1346 and a second pair of diagonally arranged second corners 1345 with a second curvature radius 1347, wherein the first curvature radius is different from the second curvature radius, in the figure the first curvature radius is five times larger than the second curvature radius. In the figure ghost circles are drawn for the first curvature radius and the second curvature radius. The light source 14, 1342 is a LED cluster of four LEDs 1348 symmetrically arranged at the square base 12 around a central LED point 1343. Each LED of said cluster of four LEDs may have a respective associated lens, or the LEDs of said cluster of four LEDs may share a common lens. The present invention is at least partly based on the understanding that by designing the reflector cup so that different regions of the reflective side wall at different locations around the optical axis have different curvatures, a more even luminance distribution in the cup may be achieved, even when the light emission window or the light source has a rounded rectangular shape. In other words, the regions/cup sides with different curvatures allows to significantly improve the uniformity of the luminance over the different cup sides. The diagonally different pairs of rounded corners enable to transform the light beam pattern from an normal symmetric light beam towards a specific, desired asymmetric beam pattern. Yet, the normal symmetric beam is can still be obtained by arranging a cluster of four such reflector cups around a central point 1352 so as to form a rotationally and/or mirror symmetric cup arrangement. The first curvature radius 1346 can be constant or can slight vary over the angle of the first corner 1344. If the first radius varies over the angle, then the average radius is taken as the first curvature radius. Similarly, this applies to the second curvature radius 1347. Typically, the first curvature radius 1346 is larger than the second curvature radius 1347 by a factor in the range of 3 to 10, such as 5 or 8. The rounded rectangular light emission window 16 is substantially shaped as a rhomboid leaf, i.e. resembles the shape of a rhomboid leaf.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A reflector cup comprising:
a square base for a light source;
a rounded rectangular light emission window opposite the base, wherein the light emission window has a larger area than the base;
an optical axis extending through the base and the light emission window; and
a circumferential reflective side wall extending around the optical axis and connecting the base and the light emission window,
wherein different regions of the reflective side wall at different locations around the optical axis have different curvatures as seen in a plane in which the optical axis extends, and
wherein the circumferential side wall comprises a first pair of diagonally arranged first corners with a first curvature radius and a second pair of diagonally arranged second corners with a second curvature radius, wherein the first curvature radius is different from the second curvature radius.

2. A reflector cup according to claim 1, wherein the light exit window substantially has a shape of a rhomboid leaf.

3. A reflector cup according to claim 1, wherein the different regions of the reflective side wall comprise at least: a first region at a first location around the optical axis, which first region has a first curvature as seen in a plane in which the optical axis extends; and a second region at a second location around the optical axis different than the first location, which second region has a second curvature different than the first curvature as seen in a plane in which the optical axis extends.

4. A reflector cup according to claim 1, wherein the different regions of the reflective side wall include two opposing first regions, one located at each end of a major axis, and two opposing second regions, one located at each end of a minor axis, wherein the curvatures of the two opposing first regions are concave as seen from outside the reflector cup, and wherein the curvatures of the two opposing second regions are convex as seen from outside the reflector cup.

5. A reflector cup according to claim 4, wherein the light exit window has two long edges parallel to the major axis and two short edges parallel to the minor axis, wherein the two opposing first regions each connects the base and a respective one of said short edges, and wherein the two opposing second regions each connects the base and a respective one of said long edges.

6. A reflector cup according to claim 5, wherein the curvature of the two opposing first regions is given by h(x) ∝ x^{A}, wherein 0.5≤A<1, wherein the curvature of the two opposing second regions is given by h(x) ∝ x^{B}, wherein 1<B≤2, and where h is height of the reflector cup along the optical axis and x is radial distance from the optical axis.

7. A reflector cup according to claim 6, wherein 0.55≤A≤0.75, such as A=0.65, and wherein 1.5≤B≤1.7, such as B=1.6.

8. A reflector cup according to claim 1, wherein the reflective side wall is at least partially transflective.

9. A reflector cup according to claim 1, wherein the reflective side wall is one of: diffusely reflecting, at least partly diffusely reflecting, and semi-specular.

10. A reflector cup according to claim 1, wherein the reflective side wall has a reflective surface with a diffusivity that varies over said surface.

11. A reflector cup according to claim 1, further comprising a light source, wherein the light source is comprised in the reflector cup and arranged at or on the base of the reflector cup.

12. A reflector cup according to claim 11, wherein the light source is comprised as an integrated, non-replaceable part with the reflector cup.

13. A luminaire comprising a plurality of reflector cups according to claim 1.

14. A luminaire according to claim 13, wherein a cluster of four reflector cups are arranged around a central point so as to form a rotationally symmetric cup arrangement.

15. A luminaire according to claim 13, further comprising a plurality of light sources, one for each reflector cup.
